(19) United States
(12) Patent Application Publication
(10) Pub. No.: US 2021/0377758 A1
(43) Pub. Date: Dec. 2, 2021

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 17/400,852

(22) Filed: Aug. 12, 2021

Related U.S. Application Data
(63) Continuation of application No. PCT/JP2020/005600, filed on Feb. 13, 2020.
(60) Provisional application No. 62/804,830, filed on Feb. 13, 2019.

(51) Int. Cl. H04W 24/04; H04W 76/19; H04W 36/00; H04W 76/10

(52) U.S. Cl. CPC H04W 24/04; H04W 76/10; H04W 36/0055; H04W 76/19

(57) ABSTRACT

A communication control method according to an embodiment is a method for controlling dual connectivity communication in which a user equipment simultaneously communicates with a master node and a secondary node. The communication control method includes detecting, by the user equipment, degradation of a radio link between a first base station and the user equipment, the first base station functioning as the master node, transmitting, by the user equipment, a first message based on the degradation of the radio link to a second base station, the second base station functioning as the secondary node, and transmitting to the first base station, by the second base station that received the first message, a second message used to recover the dual connectivity communication.

### RELATED APPLICATIONS

The present application is a continuation based on PCT Application No. PCT/JP2020/005600, filed on Feb. 13, 2020, which claims the benefit of U.S. Provisional Patent Application No. 62/804,830 filed on Feb. 13, 2019. The content of which is incorporated by reference herein in their entirety.

### TECHNICAL FIELD

The present invention relates to a communication control method in mobile communication systems.

### BACKGROUND ART

Conventionally, in the 3rd Generation Partnership Project (3GPP), a standardization project for mobile communication systems, dual connectivity is defined in which a user equipment communicates simultaneously with a master node and a secondary node. In dual connectivity, because radio resources are allocated to the user equipment from both the master node and the secondary node, high speed and highly reliable communication can be made available to the user equipment.

During communication in such dual connectivity, in a case where the user equipment detects degradation of a radio link with the master node, for example, a Radio Link Failure (RLF), the dual connectivity communication ends, and the user equipment may re-establish an RRC connection with another base station. However, a radio state between the user equipment and the master node may improve after such degradation of the radio link, and so, it is desirable to introduce a mechanism that enables the dual connectivity communication to be quickly recovered.

### SUMMARY OF INVENTION

A communication control method according to an embodiment is a method for controlling dual connectivity communication in which a user equipment simultaneously communicates with a master node and a secondary node. The communication control method includes detecting, by the user equipment, degradation of a radio link between a first base station and the user equipment, the first base station functioning as the master node, transmitting, by the user equipment, a first message based on the degradation of the radio link to a second base station, the second base station functioning as the secondary node, and transmitting to the first base station, by the second base station that received the first message, a second message used to recover the dual connectivity communication. The first message includes an information element indicating a type of the failure of the radio link, an information element indicating a measurement result of a radio state of the first base station, and an information element indicating a measurement result of a radio state of the second base station.

A user equipment according to an embodiment comprises a controller configured to perform dual connectivity communication in which the user equipment simultaneously communicates with a master node and a secondary node. The controller is configured to: detect, a failure of a radio link between a first base station and the user equipment, the first base station functioning as the master node; transmit, a first message to notify the first base station of the failure of the radio link to a second base station via a signaling bearer established between the second base station and the user equipment, the second base station functioning as the secondary node; and receive, a second message indicating an RRC configuration from the second base station via the signaling bearer, the RRC configuration being configured for the user equipment by the first base station to recover communication with the first base station. The first message includes an information element indicating a type of the failure of the radio link, an information element indicating a measurement result of a radio state of the first base station, and an information element indicating a measurement result of a radio state of the second base station.

A chipset according to an embodiment is for controlling a user equipment configured to perform dual connectivity communication in which the user equipment simultaneously communicates with a master node and a secondary node. The chipset comprises a processor and a memory coupled to the processor. The processor is configured to execute processes of: detecting, a failure of a radio link between a first base station and the user equipment, the first base station functioning as the master node; transmitting, a first message to notify the first base station of the failure of the radio link to a second base station via a signaling bearer established between the second base station and the user equipment, the second base station functioning as the secondary node; and receiving, a second message indicating an RRC configuration from the second base station via the signaling bearer, the RRC configuration being configured for the user equipment by the first base station to recover communication with the first base station. The first message includes an information element indicating a type of the failure of the radio link, an information element indicating a measurement result of a radio state of the first base station, and an information element indicating a measurement result of a radio state of the second base station.

### BRIEF DESCRIPTION OF DRAWINGS

FIG. 1 is a diagram illustrating a configuration of a mobile communication system according to an embodiment.

FIG. 2 is a diagram illustrating a configuration of a user equipment according to an embodiment.

FIG. 3 is a diagram illustrating a configuration of a base station according to the embodiment.

FIG. 4 is a diagram illustrating a configuration of a radio interface protocol stack in a user plane according to an embodiment.

FIG. 5 is a diagram illustrating a configuration of a radio interface protocol stack in a control plane according to an embodiment.

FIG. 6 is a diagram illustrating dual connectivity (DC) according to an embodiment.

FIG. 7 is a diagram illustrating operations of a mobile communication system according to a first embodiment.

FIG. 8 is a diagram illustrating operations of a mobile communication system according to a second embodiment.

FIG. 9 is a diagram according to a supplementary note.

### DESCRIPTION OF EMBODIMENTS

A mobile communication system according to an embodiment will be described with reference to the drawings. In the description of the drawings, the same or similar parts are designated with the same or similar reference signs.

### Mobile Communication System

First, a configuration of a mobile communication system according to an embodiment will be described. While the mobile communication system according to one embodiment is a 3GPP 5G system, Long Term Evolution (LTE) may be at least partially applied to the mobile communication system.

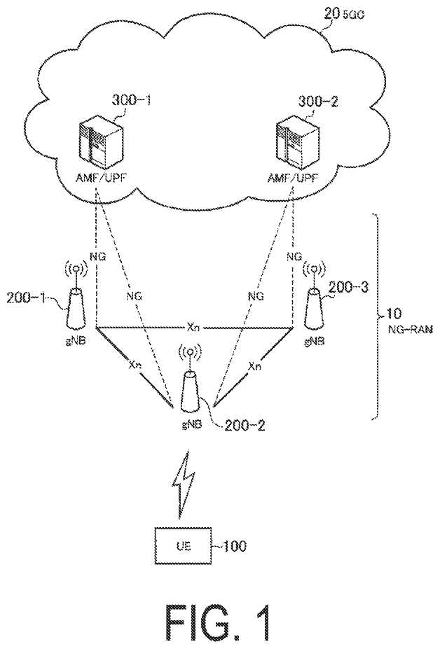

FIG. 1 is a diagram illustrating a configuration of the mobile communication system according to an embodiment.

As illustrated in FIG. 1, the mobile communication system includes a User Equipment (UE) 100, a 5G radio access network (Next Generation Radio Access Network (NG-RAN)) 10, and a 5G core network (5GC) 20.

The UE 100 is a movable apparatus. The UE 100 may be any apparatus so long as it is an apparatus utilized by a user. Examples of the UE 100 include a mobile phone terminal (including a smartphone), a tablet terminal, a laptop, a communication module (including a communication card or a chipset), a sensor or an apparatus provided in a sensor, a vehicle or an apparatus provided in a vehicle (vehicle UE), or an air vehicle or an apparatus provided in an air vehicle (aerial UE).

The NG-RAN 10 includes base stations (each of which is referred to as a “gNB” in the 5G system) 200. The gNB 200 may be also referred to as an NG-RAN node. The gNBs 200 are connected to each other via an Xn interface that is an inter-base station interface. The gNB 200 manages one or more cells. The gNB 200 performs radio communication with the UE 100 that has established a connection with a cell of the gNB 200. The gNB 200 has a radio resource management (RRM) function, a user data (hereinafter simply referred to as “data”) routing function, a measurement control function for mobility control and scheduling, and/or the like. A “cell” is used as a term that indicates a minimum unit of a radio communication area. A “cell” is also used as a term that indicates a function or resource that performs radio communication with the UE 100. One cell belongs to one carrier frequency.

Note that a gNB may be connected to an Evolved Packet Core (EPC) which is an LTE core network, or an LTE base station may be connected to a 5GC. Moreover, the LTE base station may be connected to the gNB via the inter-base station interface.

The 5GC 20 includes an Access and Mobility Management Function (AMF) and a User Plane Function (UPF) 300. The AMF performs various types of mobility control for the UE 100, and the like. The AMF manages information of an area in which the UE 100 exists by communicating with the UE 100 by using Non-Access Stratum (NAS) signaling. The UPF performs data transfer control. The AMF and the UPF are connected to the gNB 200 via an NG interface which is a base station to core network interface.

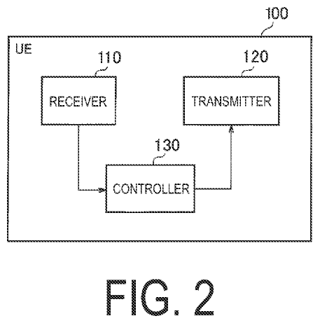

FIG. 2 is a diagram illustrating a configuration of the UE 100 (user equipment).

As illustrated in FIG. 2, the UE 100 includes a receiver 110, a transmitter 120, and a controller 130.

The receiver 110 performs various types of reception under control of the controller 130. The receiver 110 includes an antenna and a receiving unit. The receiving unit converts a radio signal received by the antenna into a baseband signal (reception signal) and outputs the signal to the controller 130.

The transmitter 120 performs various types of transmission under control of the controller 130. The transmitter 120 includes the antenna and a transmitting unit. The transmitting unit converts the baseband signal (transmission signal) output by the controller 130 into a radio signal and transmits the signal from the antenna.

The controller 130 performs various types of control in the UE 100. The controller 130 includes at least one processor and at least one memory electrically connected to the processor. The memory stores programs to be executed by the processor and information used for processing by the processor. The processor may include a baseband processor and a Central Processing Unit (CPU). The baseband processor performs modulation/demodulation and coding/decoding of the baseband signal, and the like. The CPU executes the programs stored in the memory to perform various types of process.

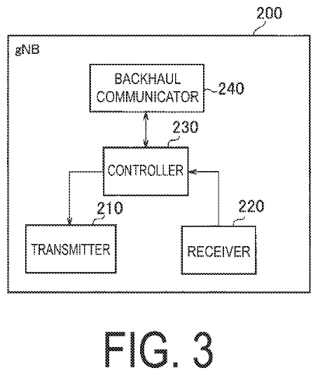

FIG. 3 is a diagram illustrating a configuration of the gNB 200 (base station).

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmitting unit. The transmitting unit converts a baseband signal (transmission signal) output by the controller 230 into a radio signal and transmits the signal from the antenna.

The receiver 220 performs various types of reception under control of the controller 230. The receiver 220 includes the antenna and a receiving unit. The receiving unit converts the radio signal received by the antenna into a baseband signal (reception signal) and outputs the signal to the controller 230.

The controller 230 performs various types of control in the gNB 200. The controller 230 includes at least one processor and at least one memory electrically connected to the processor. The memory stores programs to be executed by the processor and information used for processing by the processor. The processor may include a baseband processor and a CPU. The baseband processor performs modulation/demodulation and coding/decoding of the baseband signal, and the like. The CPU executes the programs stored in the memory to perform various types of process.

The backhaul communicator 240 is connected to a neighboring base station via the inter-base station interface. The backhaul communicator 240 is connected to the AMF/UPF 300 via the base station to core network interface. Note that the gNB may include a Central Unit (CU) and a Distributed Unit (DU) (i.e., may be functionally divided), and both units may be connected to each other via an F1 interface.

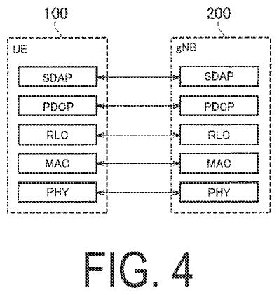

FIG. 4 is a diagram illustrating a configuration of a radio interface protocol stack in a user plane handling data.

As illustrated in FIG. 4, the radio interface protocol in the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding/decoding, modulation/demodulation, antenna mapping/demapping, and resource mapping/demapping. Data and control information are transmitted via a physical channel between the PHY layer of the UE 100 and the PHY layer of the gNB 200.

The MAC layer performs priority control of data, retransmission processing by hybrid ARQ (HARQ), a random access procedure, and the like. Data and control information are transmitted via a transport channel between the MAC layer of the UE 100 and the MAC layer of the gNB 200. The MAC layer of the gNB 200 includes a scheduler. The scheduler determines uplink and downlink transport formats (a transport block size, and a modulation and coding scheme (MCS)) and resource blocks allocated to the UE 100.

The RLC layer transmits data to the RLC layer on the receiver side using the functions of the MAC layer and PHY layer. Data and control information are transmitted between the RLC layer of the UE 100 and the RLC layer of the gNB 200 via a logical channel.

The PDCP layer performs header compression/extension and encryption/decryption.

The SDAP layer performs mapping between an IP flow that is a unit by which the core network performs QoS control and a radio bearer that is a unit by which an Access Stratum (AS) performs QoS control. Note that in a case where a RAN is connected to the EPC, SDAP is not necessary.

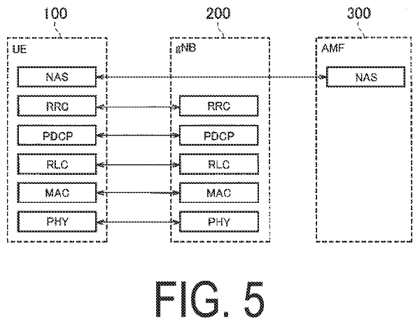

FIG. 5 is a diagram illustrating a configuration of a radio interface protocol stack in a control plane handling signaling (control signal).

As illustrated in FIG. 5, the radio interface protocol stack in the control plane includes a Radio Resource Control (RRC) layer and a Non-Access Stratum (NAS) layer instead of the SDAP layer illustrated in FIG. 4.

RRC signaling for various types of configuration is transmitted between the RRC layer of the UE 100 and the RRC layer of the gNB 200. The RRC layer controls the logical channel, the transport channel, and the physical channel in response to establishing, re-establishing, and releasing the radio bearer. In a case where there is a connection (RRC connection) between the RRC of the UE 100 and the RRC of the gNB 200, the UE 100 is in an RRC connected mode. In a case where there is no connection (RRC connection) between the RRC of the UE 100 and the RRC of the gNB 200, the UE 100 is in an RRC idle mode. In a case where the RRC connection is suspended, the UE 100 is in an RRC inactive mode.

The NAS layer located higher than the RRC layer performs session management, mobility management, and the like. NAS signaling is transmitted between the NAS layer of the UE 100 and the NAS layer of the AMF 300.

Note that the UE 100 includes an application layer or the like other than the radio interface protocol.

### Dual Connectivity

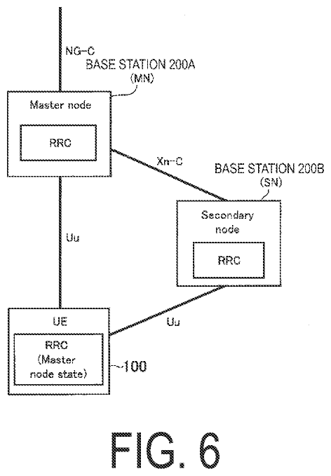

Next, a summary of dual connectivity (DC) will be described. In the following, DC including NR access is mainly assumed. Such DC may be referred to as Multi-RAT DC (MR-DC) or Multi-connectivity. FIG. 6 is a diagram illustrating an example of DC.

As illustrated in FIG. 6, in DC, the UE 100 including a plurality of transceivers is configured to utilize resources provided by two different nodes (two different base stations). One base station provides NR access and the other base station provides E-UTRA (LTE) or NR access. In the example illustrated in FIG. 6, a base station 200A (a first base station) may be an eNB or a gNB, and a base station 200B (a second base station) may be an eNB or a gNB.

One base station 200A functions as a master node (MN), and the other base station 200B functions as a secondary node (SN). The MN is a radio access node that provides control plane connection to the core network. The MN may be referred to as a master base station. The SN is a radio access node that does not have control plane connection to the core network. The SN may be referred to as a secondary base station.

The MN and the SN are connected via a network interface (inter-base station interface), and at least the MN is connected to the core network. FIG. 6 illustrates an example in which the inter-base station interface is an Xn interface; however, the inter-base station interface may be an X2 interface. The MN and the SN transmit and/or receive various messages described later via the inter-base station interface.

A group of serving cells that are cells of the MN and are configured for the UE 100 is referred to as a master cell group (MCG). On the other hand, a group of serving cells that are cells of the SN and are configured for the UE 100 is referred to as a secondary cell group (SCG).

According to DC, radio resources are allocated to the UE 100 from both the MN (MCG) and the SN (SCG) and the UE 100 simultaneously communicates with the MN and the SN, and thus, high speed and highly reliable communication can be made available to the UE 100.

The UE 100 may have a single RRC state based on the RRC and a single control plane connection to the core network by the MN. Each of the MN and SN includes an RRC entity capable of generating an RRC Protocol Data Unit (RRC PDU) to be transmitted to the UE 100.

### First Embodiment

Next, operations of the mobile communication system according to the first embodiment will be described assuming the configuration of the mobile communication system as described above.

In the first embodiment, in a case where degradation of a radio link (hereinafter referred to as an “MCG link”) between the base station 200A and the UE 100 is detected after the DC communication starts, the base station 200A functioning as the MN controls the UE 100 via the base station 200B functioning as the SN. An example in which the DC communication can be quickly recovered by the above control will be described.

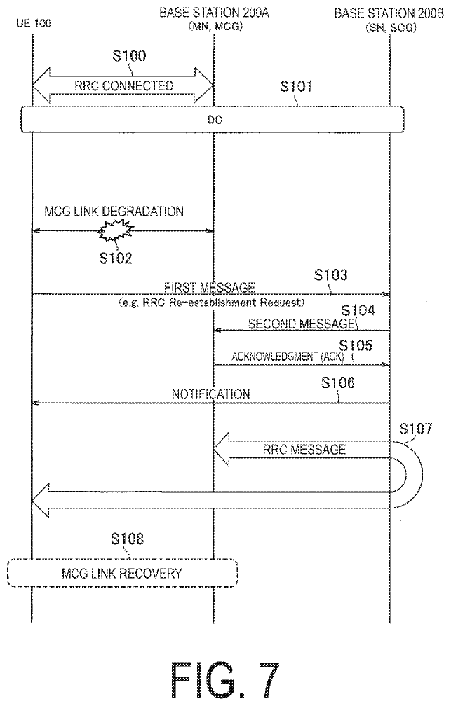

FIG. 7 is a diagram illustrating operations of a mobile communication system according to the first embodiment.

As illustrated in FIG. 7, in step S100, the UE 100 establishes an RRC connection with the base station 200A and is in the RRC connected mode.

In step S101, the UE 100 starts DC communication with the base station 200A and the base station 200B.

Here, the base station 200A may transmit to the base station 200B an Addition Request for requesting addition of the base station 200B for DC. The base station 200B may transmit a positive acknowledgment (Addition Request Ack) for the Addition Request to the base station 200A in response to receiving the Addition Request. The base station 200A may transmit an RRC message (for example, an RRC Reconfiguration message) including DC configuration information to the UE 100 in response to receiving a positive acknowledgment (Addition Request Ack).

The base station 200A may configure this operation for the UE 100 having the function of performing the operation according to the first embodiment (the MCG maintaining function via the SCG) as part of the DC configuration.

The base station 200A may configure a threshold value for detecting degradation of the MCG link for the UE 100. The threshold value may be different from a threshold value for defining a triggering condition for a measurement report. The threshold value may be a threshold value concerning a radio state for detecting a sign of an RLF. For example, the base station 200A configures the number of times N as a threshold value for the UE 100 under the assumption that an RLF is to be detected when the number of RLC retransmissions reaches M (M>N). This allows the UE 100 to detect a likelihood of an RLF at an early stage before an RLF with the MCG occurs.

As a result, the base station 200A functions as the MN, and the base station 200B functions as the SN. At least one cell of the base station 200A is configured as an MCG for the UE 100, and at least one cell of the base station 200B is configured as an SCG for the UE 100.

In step S102, the UE 100 detects degradation of the MCG link. The radio link refers to a radio connection that is in or lower than the layer 2.

Degradation of the MCG link refers to an occurrence of an RLF or an occurrence of a sign of the RLF. For example, the UE 100 detects an RLF in the case where a radio problem (e.g., loss of synchronization) occurs in the physical layer and no recovery is made within a certain period of time, or in the case where a random access procedure failure or an RLC layer failure occurs.

A sign of an RLF means that the detection threshold value of an RLF is not met, but a failure below the detection threshold value of an RLF has occurred. For example, a sign of an RLF corresponds to a prescribed number of times of occurrence of the loss of synchronization within a certain period of time in the MCG link, or a prescribed number of times of retransmission of a random access preamble in the random access procedure. These prescribed number of times may be configured as threshold values from the base station 200A.

Note that, in a case where an RLF or a sign of the RLF between the base station 200A and the UE 100 occurs, it is conceivable that the UE 100 can detect the RLF or the sign of the RLF, but the base station 200A is not capable of detecting the RLF or the sign of the RLF.

In step S103, the UE 100 transmits a first message based on degradation of the MCG link to the base station 200B functioning as the SN. Specifically, when the UE 100 detects an RLF with the base station 200A functioning as the MN or a sign of the RLF, the UE 100 reselects, on a priority basis, the base station 200B (SCG) functioning as the SN. Then, the UE 100 transmits an RRC Re-establishment Request message (first message) for requesting re-establishment of the RRC connection to the base station 200B (SCG). Alternatively, the first message may be an RRC Resume Request message for requesting recovery of the RRC connection. Alternatively, the first message may be a message indicating a connection status of the MCG link, or a measurement report message. The first message may be the same as a first message according to a second embodiment described later. The UE 100 may include, in the first message, information that the UE 100 has a function of performing the operation according to the first embodiment (the MCG maintaining function via SCG), or information that the UE 100 wants to perform the operation.

In a case where the first message is a message indicating the connection status of the MCG link, the UE 100 that detects a sign of an RLF may transmit the first message not only to the base station 200B, but also to the base station 200A.

In a case where the first message is an RRC Re-establishment Request message or an RRC Resume Request message, an RRC connection may be established between the UE 100 and the base station 200B based on the first message.

Here, the UE 100, when transmitting the RRC Re-establishment Request message, may omit the transmission of the random access preamble (Msg 1) to the base station 200B and the reception of the random access response (Msg 2) from the base station 200B. The UE 100 may include in the RRC Re-establishment Request message, a Cell-Radio Network Temporary Identifier (C-RNTI) used in the SCG during DC. Specifically, the C-RNTI is assigned to the UE 100 from each of the base station 200A and the base station 200B, and the UE 100 includes the C-RNTI assigned from the base station 200B in the RRC Re-establishment Request message. The base station 200B identifies, based on the C-RNTI included in the RRC Re-establishment Request message received from the UE 100, that the UE being a transmission source of the RRC Re-establishment Request message is the UE 100 to which the base station 200B (SN) has provided the SCG. The UE 100 may include in the RRC Re-establishment Request message a cell identifier of a primary secondary cell (PSCell) included in the SCG provided by the base station 200B (SN), in place of or in addition to the C-RNTI assigned from the base station 200B. The base station 200B may determine that the UE 100 that transmitted the RRC Re-establishment Request message including the C-RNTI assigned from the base station 200B and/or the cell identifier of the PSCell has the capability of an MCG link maintaining function via the SCG.

In step S104, the base station 200B that received the first message transmits a second message to the base station 200A, the second message being used to recover DC communication.

The second message may be a request message requesting the base station 200A to maintain an RRC connection between the base station 200A and the UE 100 or maintain a DC state. The second message may be a notification message notifying the base station 200A that the base station 200B has received from the UE 100 the RRC Re-establishment Request message. The second message may be a transfer message including the RRC Re-establishment Request message, as a container, that the base station 200B has received from the UE 100. The second message may be the same as a second message according to the second embodiment described later.

The second message includes, as information elements, the respective identifiers of the MN (base station 200A) and the SN (base station 200B) on the inter-base station interface, and a UE identifier on the inter-base station interface. In the first embodiment and the second embodiment below, the message transmitted and/or received between the base station 200A and the base station 200B includes these information elements.

The second message may be a message requesting or suggesting a split Signaling Radio Bearer (SRB) or a message including an information element requesting or suggesting the split SRB. The split SRB is split in the MN to transmit the SRB not only in the MCG but also in the SCG. The second message may notify the type of SRB (SRB1, SRB2, or both) acceptable as a split SRB.

In step S105, the base station 200A that received the second message transmits a response message for the second message to the base station 200B.

The response message may be a positive acknowledgment (Ack) to acknowledge maintaining the RRC connection between base stations 200A and the UE 100 or maintaining the DC state.

The response message may be a negative acknowledgment (Nack) to reject maintaining the RRC connection between the base station 200A and the UE 100 or maintaining the DC state. In this case, the base station 200A may transmit to the base station 200B a Handover Request message for handing over the UE 100 to the base station 200B.

The response message may include information indicating which SRB is to be a split SRB (Requested Split SRBs).

The base station 200B that received the negative acknowledgment (Nack) from the base station 200A may transmit the RRC Re-establishment message to the UE 100 in response to the RRC Re-establishment Request message received from the UE 100. Alternatively, in a case where the UE 100 does not detect an RLF with the base station 200A, the base station 200B that received a negative acknowledgment (Nack) from the base station 200A may transmit, to the UE 100, a message or information element that prompts the UE 100 to detect an RLF to cause the UE 100 to perform Re-establishment. The message prompting the UE 100 to detect an RLF may be an RRC Re-establishment Reject message. In a case where the UE 100 has received a message prompting the UE 100 to detect an RLF, the UE 100 continues to communicate with the base station 200A (MCG), and monitors for an RLF.

In the following, the description proceeds under the assumption that the response message received by the base station 200B is a positive acknowledgment (Ack).

In step S106, the base station 200B that received a positive acknowledgment (Ack) transmits to the UE 100 a message notifying that the RRC connection with the base station 200A is maintained via the base station 200B (SCG link). In this state, the RRC connection between the UE 100 and the base station 200A is not physically via the MCG managed by the base station 200A. As such, the UE 100 may stop monitoring for an RLF for the base station 200A (MCG) and other procedures (e.g., PUCCH transmission, DRX operation, and the like). However, the UE 100 performs measurement of the radio state for the base station 200A.

In step S107, an RRC message is transmitted and/or received between the UE 100 and the base station 200A via the base station 200B while maintaining the RRC connection between the UE 100 and the base station 200A. The RRC message refers to a message transmitted and/or received in the RRC layer.

Here, the RRC message from the base station 200A to the UE 100 is transferred via the inter-base station interface to the base station 200B, and, thereafter, transmitted in an RRC container transmitted on a signaling radio bearer (SRB) 3 from the base station 200B to the UE 100. The SRB 3 refers to a radio bearer for control established between the UE 100 and the SN.

The RRC message from the UE 100 to the base station 200A is transmitted in the RRC container transmitted on the SRB 3 to the base station 200B, and thereafter, transferred from the base station 200B to the base station 200A via the inter-base station interface.

The RRC container transmitted on such an SRB 3 may be a dedicated RRC container that can be used only in a case where the operation according to the first embodiment (i.e., the MCG connection via the SCG link) is active.

The state in step S107 may be considered as a state in which the UE 100 has an RRC connection with each of the base station 200A and the base station 200B. In this case, the RRC connection established between the UE 100 and the base station 200A may be suspended or deactivated. The UE 100 may be in the RRC inactive mode. Since the link state with the MCG is poor, the UE 100 can detect an RLF when the UE 100 maintains the RRC connected mode. Thus, the RRC connection between the UE 100 and the base station 200A may be suspended.

Note that the RRC of the UE 100 connected to the MCG may be a master RRC (M-RRC) and the RRC of the UE 100 connected to the SCG may be a secondary RRC (S-RRC). The M-RRC of the UE 100 may give an instruction to select a cell to which the S-RRC of the UE 100 is to be connected. Here, the M-RRC of the UE 100 may configure for the S-RRC a list of candidate cells to which the S-RRC is to be connected. Because it is difficult to control which cell the S-RRC is to be connected to, the M-RRC of the UE 100 specifies a cell to which the S-RRC of the UE 100 is to be connected. For example, in order to obtain a diversity gain, control to separate the frequencies of the cells to which the M-RRC and the S-RRC are to be connected, or to cause the S-RRC to select a cell different from the cell to which the M-RRC is connected, is possible.

The UE 100 may transmit the measurement report in the RRC container to the base station 200A via the base station 200B. The measurement report includes measurement results obtained by measuring the radio state of each cell by the UE 100. A case may be assumed that the base station 200A determines that, for example, the radio state between the UE 100 and the base station 200A has improved, based on the measurement report from the UE 100 (step S108). In this case, the base station 200A may transmit control information in the RRC container for recovering the DC connection (the RRC connection between the UE 100 and the base station 200A), to the UE 100 via the base station 200B. The control information includes a contention-free random access preamble used for the random access procedure to the base station 200A, a radio configuration used for radio communication with the base station 200A, and the like.

In a case where it is determined that the radio state between the UE 100 and the base station 200A has improved (step S108), for example, the UE 100 may transmit a message (e.g., an RRC Re-Request message) for re-requesting the RRC connection, to the base station 200A via the base station 200B. The base station 200A may transmit a response message for the message to the UE 100 via the base station 200B. The response message may include information indicating that DC is to be recovered based on the previous DC configuration information.

In step S108, the UE 100 and the base station 200A recover the MCG link. Here, the UE 100 may transmit a notification that the MCG link has improved, in the RRC container to the base station 200A via the base station 200B. The base station 200A may transmit a response for the notification from the UE 100 directly to the UE 100 by way of, for example, an RRC Reconfiguration message via the MCG link. Alternatively, the base station 200A may transmit the response for the notification from the UE 100, in the RRC container to the UE 100 via the base station 200B.

On the other hand, in a case where the radio state of the MCG link does not improve even if a certain period of time elapses (i.e., in a case where the MCG link cannot be re-established), the base station 200A may hand over the UE 100 to the base station 200B to hand off the RRC connection to the base station 200B. In this case, DC ends, and the UE 100 communicates only with the base station 200B.

The certain period of time described above may be configured by a timer. The base station 200A may configure a timer for the base station 200B. The base station 200B may start the timer upon reception of the first message from the UE 100 (step S103). The base station 200B may configure (notify) a timer for the base station 200A. The base station 200A may start the timer upon reception of the second message from the base station 200B (step S104) or upon transmission of a positive acknowledgment (Ack) (step S105). The base station 200A may configure a timer for the UE 100. The UE 100 may start the timer upon detection of degradation of the MCG link. In a case where the timer expires without recovery of the MCG link, the UE 100 may automatically perform a handover to the base station 200B without receiving a handover indication from the base station 200A.

According to the first embodiment, in a case where degradation of the MCG link is detected after the DC communication starts, the RRC message is transmitted and/or received between the UE 100 and the base station 200A via the base station 200B while maintaining the RRC connection between the UE 100 and the base station 200A. This allows the base station 200A to perform various types of control on the UE 100 via the SCG even in a case where an RLF of the MCG link occurs. Therefore, the DC communication can be quickly recovered in a case where the radio state of the MCG improves.

### Second Embodiment

Next, operations of a mobile communication system according to a second embodiment will be described focusing on differences from the first embodiment.

In the second embodiment, an example will be described in which, in a case where degradation of the MCG link is detected after the DC communication starts, the roles of the MN and the SN are switched between the base station 200A and the base station 200B (hereinafter, appropriately referred to as “Role Change”) so that the DC communication can be quickly recovered.

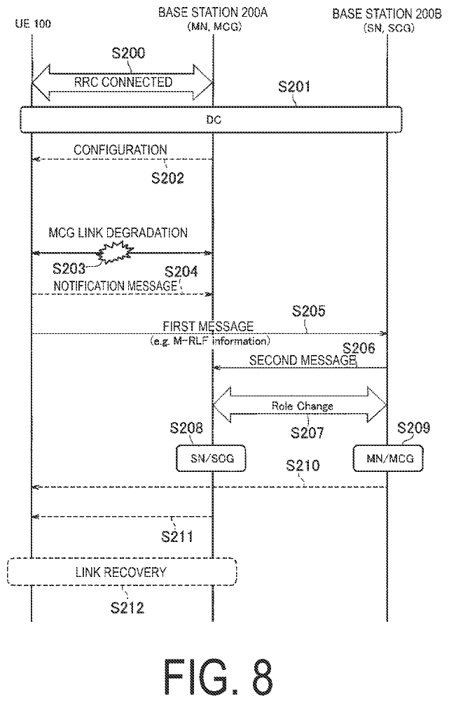

FIG. 8 is a diagram illustrating operations of the mobile communication system according to the second embodiment.

As illustrated in FIG. 8, in step S200, the UE 100 establishes an RRC connection with the base station 200A and is in the RRC connected mode.

In step S201, the UE 100 starts DC communication with the base station 200A and the base station 200B.

Here, the base station 200A may transmit to the base station 200B an Addition Request for requesting addition of the base station 200B for DC. The base station 200B may transmit a positive acknowledgment (Addition Request Ack) for the Addition Request to the base station 200A in response to receiving the Addition Request.

The base station 200A may transmit an RRC message including DC configuration information to the UE 100 in response to receiving a positive acknowledgment (Addition Request Ack) (step S202).

As a result, the base station 200A functions as the MN, and the base station 200B functions as the SN. At least one cell of the base station 200A is configured as an MCG for the UE 100, and at least one cell of the base station 200B is configured as an SCG for the UE 100.

In step S202, the base station 200A may configure a threshold value for detecting degradation of the MCG link for the UE 100. The threshold value may be different from a threshold value for defining a triggering condition for a measurement report. The threshold value may be a threshold value concerning a radio state for detecting a sign of an RLF. For example, the base station 200A configures the number of times N as a threshold value for the UE 100 under the assumption that an RLF is to be detected when the number of RLC retransmissions reaches M (M>N). This allows the UE 100 to detect a likelihood of an RLF at an early stage before an RLF with the MCG occurs.

In step S202, the base station 200A may transmit configuration information to be used after the Role Change to the UE 100 in advance. Specifically, the base station 200A transmits a plurality of RRC configurations to the UE 100. A first RRC configuration of these RRC configurations is configuration information to be used immediately for the MCG link and is active when configured for the UE 100. At least one second RRC configuration of these RRC configurations is configuration information to be used after the Role Change, and is in a standby state (inactive) when configured for the UE 100.

The base station 200A may include the plurality of RRC configurations in one RRC Reconfiguration message to transmit collectively the plurality of RRC configurations to the UE 100. Alternatively, the base station 200A may transmit the first RRC configuration to the UE 100 in advance, and then additionally transmit the second RRC configuration to the UE 100. The base station 200A may specify and delete any of the plurality of RRC configurations for the UE 100. Each of the plurality of RRC configurations may be associated with the cell identifier. The base station 200A may transmit a plurality of sets of RRC configuration and cell identifier to the UE 100. For example, the UE 100 uses different RRC configurations by activating the corresponding RRC configuration for each cell in the MCG.

In step S203, the UE 100 detects degradation of the MCG link.

As described above, degradation of the MCG link refers to an occurrence of an RLF or a sign of the RLF. For example, the UE 100 detects an RLF in the case where a radio problem (e.g., loss of synchronization) occurs in the physical layer and no recovery is made within a certain period of time, or in the case where a random access procedure failure or an RLC layer failure occurs.

A sign of an RLF means that the detection threshold value of an RLF is not met, but a failure below the detection threshold value of an RLF has occurred. For example, a sign of an RLF corresponds to a prescribed number of times of occurrence of the loss of synchronization within a certain period of time in the MCG link, or a prescribed number of times of retransmission of a random access preamble in the random access procedure. These prescribed number of times may be configured as threshold values from the base station 200A.

Note that, in a case where an RLF or a sign of the RLF between the base station 200A and the UE 100 occurs, it is conceivable that the UE 100 can detect the RLF or the sign of the RLF, but the base station 200A is not capable of detecting the RLF or the sign of the RLF.

In step S204, the UE 100 detecting a sign of an RLF may transmit a message notifying a likelihood of an RLF to the base station 200A. The message may be a message different from the measurement report or may be a request message requesting a Role Change. The UE 100 may transmit the message to the base station 200A by using the SRB (SRB 1) that is associated with a MAC entity for the MCG. The base station 200A may perform the Role Change (step S207), based on receiving the message notifying a likelihood of an RLF.

In step S205, the UE 100 transmits the first message based on degradation of the MCG link to the base station 200B functioning as the SN. The UE 100 detecting a sign of an RLF may transmit the message to the base station 200A in step S204, and may transmit the first message to the base station 200B in step S205.

The first message may be a message indicating that the UE 100 has detected an RLF with the base station 200A (MCG link) or a sign of the RLF. Such a message may be referred to as an M-RLF information message. The first message may be a measurement report message. The UE 100 transmits the M-RLF information message or the measurement report message to the base station 200B by using the SRB (SRB 3) that is associated with a MAC entity for the SCG.

The first message may include at least one of an information element indicating a type of failure (any of T310 expiration, random access failure, and RLC retransmission upper limit arrival) and an information element indicating a measurement result of the radio state.

In step S206, the base station 200B transmits the second message to the base station 200A, based on the first message received from the UE 100.

The second message may be a notification message indicating that an RLF on the MCG link or a sign of the RLF has been detected, or may be a request message for the base station 200B to serve as the MN.

The second message may include at least one of a PDCP Change Indication which is an information element indicating whether or not PDCP data recovery is necessary, and a container for carrying the RRC information element.

In step S207, the base station 200A and the base station 200B perform the Role Change.

In a case where the second message is the request message (Role Change request message) for the base station 200B to serve as the MN, the base station 200A, in step S207, may transmit a response message (Ack or Nack) for this Role Change request message to the base station 200B.

Alternatively, in step S207, the base station 200A may transmit the Role Change request message to the base station 200B, based on the message received from the UE 100 in step S204 or the second message received from the base station 200B in step S206. The Role Change request message may include various configuration information required for the base station 200B to serve as the MN. The base station 200B that received the Role Change request message may transmit a response message (Ack or Nack) for the Role Change request message to the base station 200A.

As a result, the base station 200A is changed to the SN (step S208), and the base station 200B is changed to the MN (step S209).

At least one of the base station 200A and the base station 200B may transmit a message indicating that the Role Change has been performed to the UE 100 (step S210, step S211). The message indicating that the Role Change has been performed may include at least one of a cell identifier of each cell included in the new MCG and a cell identifier of each cell included in the SCG.

The UE 100 confirms that the Role Change has been performed based on the message received in step S210 and/or step S211.

A case is assumed that the UE 100 confirming that the Role Change has been performed has received in step S202 the plurality of RRC configurations (the first RRC configuration and the second RRC configuration) from the base station 200A. In this case, the second RRC configuration that has been in standby is activated, and application of the second RRC configuration is started. There is a case where a plurality of second RRC configurations exist, and each second RRC configuration is associated with a cell identifier. In this case, the UE 100 may activate the second RRC configuration, of the plurality of second RRC configurations, which is associated with the cell identity of the cell of the new MCG, and may discard remaining second RRC configurations or maintain the remaining second RRC configurations in the standby state. Whether the UE 100 discards or maintains the remaining second RRC configurations may be determined by a configuration from the base station 200A (step S202).

Note that the UE 100 may activate the second RRC configuration that has been in standby, being triggered under a condition different from receiving the message in step S210 and/or step S211. For example, the UE 100 may activate the second RRC configuration that has been in standby, being triggered by transmitting the message in step S204 or transmitting the message in step S205.

In a case where the state of the radio state of the base station 200A functioning as the SN improves (step S212), the UE 100 can transmit and/or receive data to and from the base station 200A. On the other hand, in a case where the radio state of the base station 200A does not improve even if a certain period of time elapses, the base station 200B functioning as the MN transmits a release message to the base station 200A. Thus, the base station 200B functioning as the MN may release the base station 200A functioning as the SN. In this case, DC ends, and the UE 100 communicates only with the base station 200B. The method for configuring the certain period of time is the same as in the first embodiment.

According to the second embodiment, in a case where degradation of the link of the base station 200A is detected after DC communication starts, the roles of the MN and the SN are switched between the base station 200A and the base station 200B. As a result, the base station 200B newly serving as the MN can control the UE 100 while the base station 200A is maintained as the SN. Therefore, the DC communication can be quickly recovered in a case where the radio state of the base station 200A improves.

### Other Embodiments

At least some of the operations according to the first embodiment and at least some of the operations according to the second embodiment may be performed in combination.

As another embodiment, at least some of the operations according to the first embodiment and at least some of the operations according to the second embodiment may be applied to carrier aggregation (CA). In the case of application to CA, the MN and the MCG are interpreted as primary cells (PCell), and the SN and the SCG are interpreted as secondary cells (SCell).

As another embodiment, the UE 100 may perform DC communication with a base station and another UE. Specifically, the UE 100 performs simultaneous communication with the base station and another UE via a Uu interface with the base station and a PC5 interface (sidelink) with the other UE, respectively. Under such an assumption, the above-described M-RRC may be an RRC for the base station (Uu), and the above-described S-RRC may be an RRC for another UE (PC5).

A program causing a computer to execute each of the processes performed by the UE 100 or the gNB 200 may be provided. The program may be recorded in a computer readable medium. Use of a computer readable medium enables the program to be installed on a computer. Here, the computer readable medium on which the program is recorded may be a non-transitory recording medium. The non-transitory recording medium is not particularly limited, and may be, for example, a recording medium such as a CD-ROM, a DVD-ROM, or the like.

Circuits for performing the processes performed by the UE 100 or the gNB 200 may be integrated to configure at least a portion of the UE 100 or the gNB 200 as a semiconductor integrated circuit (chipset, SoC).

An embodiment has been described above in detail with reference to the drawings; however, specific configurations are not limited to those described above, and various design modifications can be made without departing from the gist of the present disclosure.

### Supplementary Note

### Introduction

The RAN plenary approved a work item for the extension of multi-RAT dual connectivity and carrier aggregation. One object of this work item is to support fast recovery of the mechanism of the MCG link.

Fast recovery: To support fast recovery of an MCG link, for example, an SCG link and a split SRB are utilized to support recovery in a case of an MCG failure during operation in MR-DC (Multi-RAT dual connectivity).

### Discussion

In this supplementary note, the direction for solutions for fast MCG link recovery will be discussed.

The dual connectivity utilizes radio resources served from two nodes (e.g., eNB or gNB). While the secondary node provides the SCG link to the UE, the master node provides the MCG link to the UE and the core network. For example, it is expected that gains from site diversity and frequency diversity are expected to improve multiple links or the MCG and the SCG not only in terms of user throughput, but also in terms of the stability of the connection.

In the current specification, the RLF is declared separately for the MCG and the SCG, and, while the transmission of the SCG is suspended in the SCG RLF, the UE starts an RRC re-establishment procedure in the MCG RLF. In other words, the existing dual connectivity contributes to robustness in a case of an SCG failure, but there is no gain for the MCG failure. In other words, there is no difference between single connectivity and dual connectivity with respect to the stability of the MCG link. In dual connectivity, the MCG link is a micro cell, and therefore, may be assumed to be always stable, and the SCG link is a small cell link, and therefore, may be assumed to be unreliable. However, in practice, such assumptions are not always correct. For example, when a user enters a building, an indoor small cell provides a more stable connection than an outdoor micro cell. The WID illustrates a solution for fast MCG failure recovery “by utilizing the SCG link and the split SRB in the recovery in the case of MCG failure during operation in MR-DC”. Accordingly, a method for utilizing an SCG resource in dual connectivity is one object of the work item.

Proposal 1: RAN2 should introduce fast MCG failure recovery by utilizing an SCG link or a split SRB.

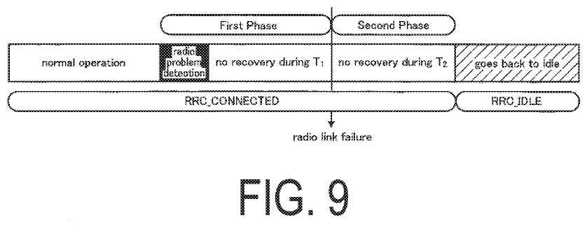

In the case of agreeing to Proposal 1, the procedure for an RLF is a candidate for extension for fast recovery. In the current specification, after the RLF is declared, the UE selects a suitable cell and starts the RRC re-establishment procedure. Thereby, the modeling is very similar to that presented by LTE. FIG. 9 is a diagram of an example of an RLF peripheral procedure in LTE. The cell, upon receiving the RRC re-establishment request, already has or regains a UE context, and grants the UE permission to maintain the RRC connected mode. In consideration of a likelihood of an SCG link, RAN2 should utilize this to quickly recover an MCG link.

Proposal 2: RAN2 should extend the procedure for the MCG RLF in dual connectivity when the SCG link is good.

In the case of agreeing to Proposal 2, several solutions as described below are considered.

Option 1: UE-Based Fast Recovery (Highly Responsive Recovery)

The extension of the RRC re-establishment procedure is discussed. For example, since the SN is expected to have a good radio link quality and already has UE context, in the case of an MCG RLF, the UE in dual connectivity prioritizes the current SCG in the cell re-selection of the RRC re-establishment request. The delay involved in the RRC re-establishment and random access procedure is minimized, and the first MCG is temporarily allowed to control the UE.

Option 2: NW-Based Fast Recovery (Aggressive Recovery)

Similar to that discussed in LTE feMOB, the type of role change for the MN (master node) and the SN (secondary node) will be considered. For example, in a case where an RLF occurs at the MCG link, the role of the MCG is exchanged for the current SCG link. As such, MCG failure is expected to be avoided in advance, and delays associated with the random access procedure may also be avoided. Via the SRB 3, the UE may notify the SN of the likelihood of MCG RLF, and the SN may properly control the UE.

Option 3: Recovery by Combination of Options 1 and 2

Even after aggressive recovery fails, the highly responsive recovery is still operational, and therefore, the overall robustness is improved even if Options 1 and 2 are supported independently.

Option 1 is a simple solution. Option 2 is slightly more complex than Option 1, but Option 2 can potentially eliminate the time of interruption for all services. Option 3 is discussed later after Option 1 and Option 2 are established.

Proposal 3: RAN2 should discuss the option for UE-based highly responsive recovery and/or NW-based aggressive recovery of the MCG RLF.

1. A communication control method for controlling dual connectivity communication in which a user equipment simultaneously communicates with a master node and a secondary node, the communication control method comprising:
detecting, by the user equipment, a failure of a radio link between a first base station and the user equipment, the first base station functioning as the master node;
transmitting, by the user equipment, a first message to notify the first base station of the failure of the radio link to a second base station via a signaling bearer established between the second base station and the user equipment, the second base station functioning as the secondary node; and
receiving, by the user equipment, a second message indicating an RRC configuration from the second base station via the signaling bearer, the RRC configuration being configured for the user equipment by the first base station to recover communication with the first base station wherein
the first message includes an information element indicating a type of the failure of the radio link, an information element indicating a measurement result of a radio state of the first base station, and an information element indicating a measurement result of a radio state of the second base station.

2. The communication control method according to claim 1, further comprising:
continuing, by the user equipment, to measure a radio environment for the first base station after the detection of the failure of the radio link.

3. The communication control method according to claim 1, further comprising:
starting, by the user equipment, a timer in response to the user equipment transmitting the first message; and
performing, by the user equipment, a procedure for establishing an RRC connection in a case where the timer expires without recovery of communication with the first base station.

4. The communication control method according to claim 1, further comprising:
transmitting, by the first base station, a message for performing a handover in response to the first message.

5. A user equipment comprising a controller configured to perform dual connectivity communication in which the user equipment simultaneously communicates with a master node and a secondary node, wherein
the controller is configured to:
detect, a failure of a radio link between a first base station and the user equipment, the first base station functioning as the master node;
transmit, a first message to notify the first base station of the failure of the radio link to a second base station via a signaling bearer established between the second base station and the user equipment, the second base station functioning as the secondary node; and
receive, a second message indicating an RRC configuration from the second base station via the signaling bearer, the RRC configuration being configured for the user equipment by the first base station to recover communication with the first base station wherein
the first message includes an information element indicating a type of the failure of the radio link, an information element indicating a measurement result of a radio state of the first base station, and an information element indicating a measurement result of a radio state of the second base station.

6. A chipset for controlling a user equipment configured to perform dual connectivity communication in which the user equipment simultaneously communicates with a master node and a secondary node, the chipset comrising: a processor and a memory coupled to the processor, the processor configured to execute processes of:
detecting, a failure of a radio link between a first base station and the user equipment, the first base station functioning as the master node;
transmitting, a first message to notify the first base station of the failure of the radio link to a second base station via a signaling bearer established between the second base station and the user equipment, the second base station functioning as the secondary node; and
receiving, a second message indicating an RRC configuration from the second base station via the signaling bearer, the RRC configuration being configured for the user equipment by the first base station to recover communication with the first base station wherein
the first message includes an information element indicating a type of the failure of the radio link, an information element indicating a measurement result of a radio state of the first base station, and an information element indicating a measurement result of a radio state of the second base station.
